(19) United States
(12) Patent Application Publication
(10) Pub. No.: US 2026/0112527 A1
(43) Pub. Date: Apr. 23, 2026

(54) CERAMIC-CORE INDUCTOR COMPONENT

(71) Applicant: Knowles (UK) Limited, Norwich (GB)

(72) Inventors: George W. Kerridge, Norwich (GB); Matthew J. Ellis, Norwich (GB); Aaron J. Ellis, Norwich (GB); Peter M. Marley, Chittenago, NY (US); Stephen A. Costantino, Cazenovia, NY (US)

(21) Appl. No.: 19/008,957

(22) Filed: Jan. 3, 2025

Related U.S. Application Data
(60) Provisional application No. 63/708,277, filed on Oct. 17, 2024.

(51) Int. Cl. H01F 3/08; H01F 5/04

(52) U.S. Cl. CPC H01F 3/08; H01F 5/04

(57) ABSTRACT

A ceramic-core inductor component includes a wire coil disposed about a portion of a ceramic-core having a dielectric constant of 8 or less and electrically connected to conductive pads disposed on corresponding standoffs, wherein the ceramic-core inductor component has improved performance attributable to a higher quality factor and a higher self-resonant frequency.

### CLAIM OF PRIORITY

This application claims the benefit of U.S. Application No. 63/708,277, filed Oct. 17, 2024, the contents of which are incorporated by reference for all purposes as if fully set forth herein.

### FIELD OF THE DISCLOSURE

The present disclosure relates generally to non-magnetic inductor components and more particularly to ceramic-core inductor components for radio frequency (RF) applications and configurable for mounting on a printed circuit board.

### BACKGROUND

Ceramic-core inductor components are commonly integrated with increasingly smaller electrical circuits and host devices for use in certain radio frequency (RF) applications where reduced size and performance are of paramount importance. Such applications include hand-held communication devices, laptop computers, military and commercial aircraft, and space vehicles among others. For these and other applications, ceramic-core inductors generally exhibit better performance than ferrite-core inductors. The improved performance is largely attributable to the low permeability of the ceramic-core. Ceramic-core inductors store energy more efficiently, have a higher quality (Q) factor, a higher self-resonant frequency (SRF) and better temperature stability than ferrite-core inductors. Nevertheless, there is an ongoing need for further performance improvements in ceramic-core inductor components.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and implementations and are not considered to limit application of the teachings of the disclosure or the invention, the scope of which is set forth by the appended claims.

FIG. 1 is a perspective view of a representative ceramic-core inductor component.

FIG. 2 is a side view of the inductor component of FIG. 1.

FIG. 3 is a partial sectional side view of the inductor component of FIG. 2.

FIG. 4 is a bottom view of the inductor component of FIG. 2.

FIG. 5 is representative ceramic-core blank.

FIG. 6 is an end view of the ceramic-core blank of FIG. 5.

FIG. 7 is an alternative ceramic-core blank.

FIG. 8 is a side view of the ceramic-core blank of FIG. 7 comprising electrical terminations formed on standoffs.

FIG. 9 is a bottom view of the ceramic-core blank of FIG. 8.

FIG. 10 shows comparative Q factor versus frequency plots for 1 micro-Henry (μH) ceramic-core inductor components of the prior art and present disclosure.

FIG. 11 shows comparative inductance versus frequency plots for the 1 μH ceramic-core inductor components of FIG. 10.

FIG. 12 shows comparative Q factor versus frequency plots for 470 nano-Henry (nH) ceramic-core inductor components of the prior art and present disclosure.

FIG. 13 shows comparative inductance versus frequency plots for the 470 nH ceramic-core inductor components of FIG. 12.

FIG. 14 shows comparative Q factor versus frequency plots for 12 nano-Henry (nH) ceramic-core inductor components of the prior art and present disclosure.

FIG. 15 shows comparative inductance versus frequency plots for the 12 nH ceramic-core inductor components of FIG. 14.

Those of ordinary skill in the art will appreciate that the drawings are illustrated for simplicity and clarity and therefore may not be drawn to scale and may not include well-known features, that the order of occurrence of actions or steps may be different than the representative order described, that some or all of such actions or steps may be performed concurrently unless specified otherwise, and that the terms and expressions used herein have meanings understood by those of ordinary skill in the art except where a different meaning is specifically attributed to them.

### DETAILED DESCRIPTION

The disclosure relates generally to ceramic-core inductor components for radio frequency (RF) applications having improved performance. The ceramic-core inductor components described herein are suitable for use in filters, low noise amplifiers (LNAs), power supplies, oscillators, impedance matching circuits, servos, and other controllers, among a variety of other electrical circuits. Such circuits are found in space and terrestrial communications systems, radar systems, as well as automotive, medical, industrial and consumer electronics, among many other systems and applications.

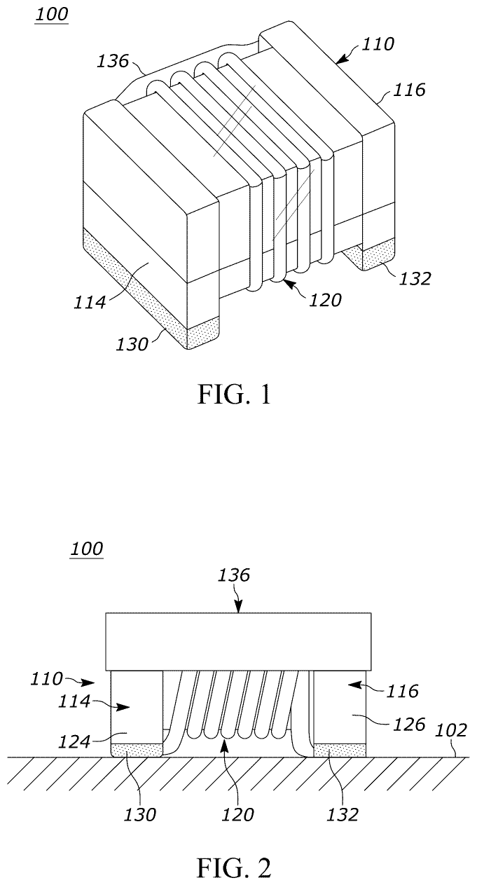

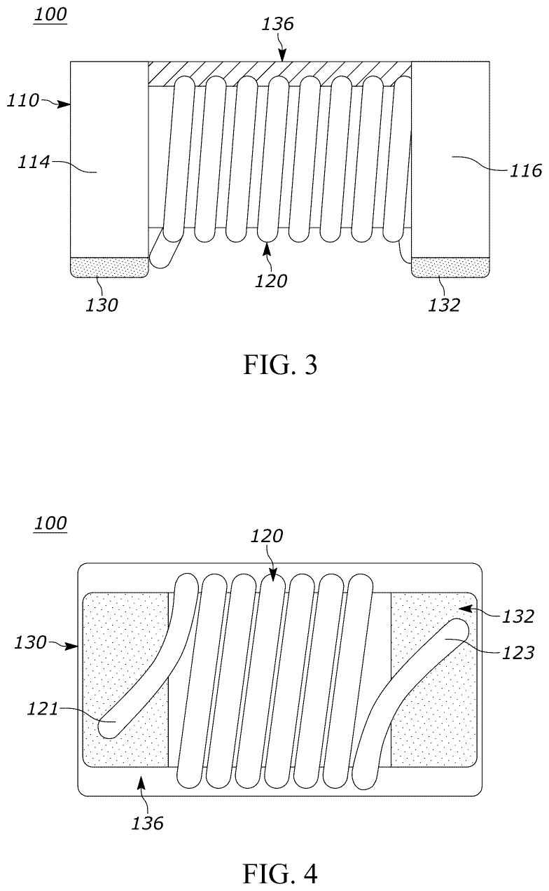

The ceramic-core inductor components described herein generally comprise a conductive coil wound about a ceramic-core. In FIGS. 1-3, a representative inductor component 100 comprises a ceramic-core 110 supporting a conductive coil 120 wound about a body portion of the ceramic-core, between first and second ceramic standoffs thereof. The conductive coil comprises end portions electrically connected to corresponding electrical terminals (also referred to herein as “terminations”) integrated with the ceramic-core. These and other aspects of ceramic-core inductor components are described further herein.

The ceramic-core inductor components described herein have a dielectric constant (K) selected to reduce parasitic loss (e.g., parasitic capacitance) thereby improving inductor performance. The improved performance is characterized by a higher quality (Q) factor and higher self-resonant frequency (SRF) than comparable prior art ceramic-core inductors. The Q factor is a ratio of inductive reactance to a resistance of the inductor, X_{L}/R_{L}, where the inductive reactance is a function of inductance L and parasitic capacitance. The higher SRF is attributable to lower parasitic capacitance.

The dielectric constant is a material characteristic considered in the design of capacitors, not inductors. The inventors of the ceramic-core inductors described herein have nevertheless recognized that the self-resonant frequency (SRF) of ceramic-core inductors has an inverse relation to the dielectric constant (κ) of the ceramic-core and that appropriate selection of the ceramic-core based on the κ value can improve inductor performance. Representative ceramic-core inductor components described herein having a κ value of 8 or less are shown to have improved quality (Q) factor and SRF compared to prior art ceramic-core inductors having higher κ values. Representative ceramic-core inductors and ceramic compositions therefor are described herein.

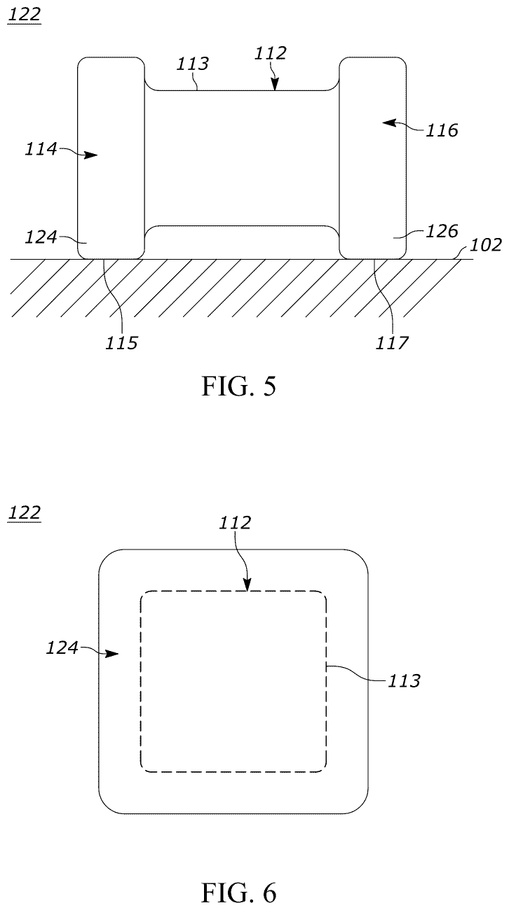

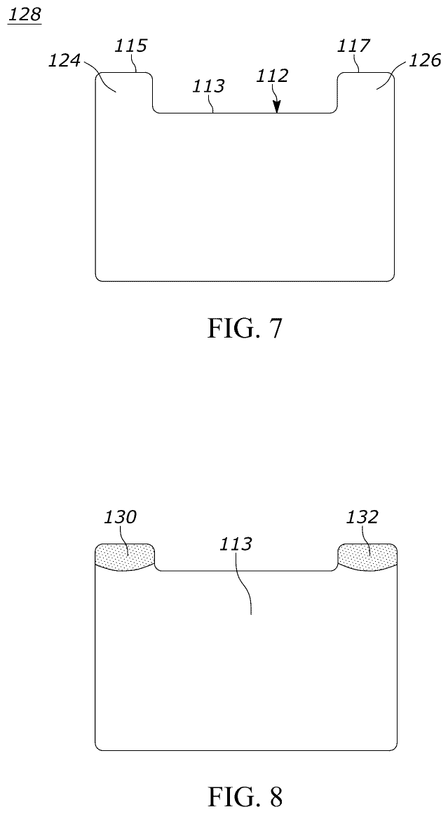

In FIGS. 5-6, a representative ceramic-core blank 122 comprises a body portion 112 between first and second flanges 114 and 116 radially extending beyond a periphery 113 of the body portion. Each flange or a portion thereof includes a mounting surface constituting a standoff for mounting on a host mounting surface 102. In FIG. 5, the standoffs 124 and 126 each include a corresponding end surface 115 and 117 on which the electrical terminals can be located as described further herein. Alternatively, the terminations can be located on a portion of the ceramic-core apart from the standoffs 124 and 126.

The body portion and the radial flanges can both have polygonal cross-sections, for example a square cross-section shown in FIG. 6. In other implementations, the body portion and the flanges can both have circular cross-sections, and one or more flat surfaces can be provided on each flange for surface mounting or for electrical terminals as described herein. Alternatively, the body portion can have a circular cross section and the flanges can have a polygonal cross-section. In still other implementations, the ceramic-core blank is devoid of flanges extending radially outwardly of the body portion.

In FIG. 7, an alternative ceramic-core blank 128 comprises a body portion 112 located between first and second flanges comprising corresponding standoffs 124 and 126 with corresponding mounting surfaces 115 and 117, respectively. The alternative ceramic-core blank 128 comprises a four-sided polygonal cross-section and the standoffs extend beyond a peripheral portion 113 of at least one side of the body portion.

The ceramic-cores of FIGS. 5-9 can comprise other shapes and configurations and can be formed by isostatic or mechanical pressing, or molding among other known and future ceramic forming operations, before firing.

The constituents of the ceramic-core composition depend generally on the required performance characteristics of the inductor component. The ceramic-core can comprise one or more of calcium-strontium tungstate, magnesium silicate, magnesium aluminate, magnesium aluminum silicate, calcium silicate, zinc silicate, aluminum silicate or silica, or a combination of two or more thereof, alone or in combination with other elements or compounds. Each of the foregoing elements or compounds has a dielectric constant (κ) of 8 or less. Aluminum silicate, magnesium aluminum silicate, and silica each have a dielectric constant of 6 or less. Magnesium aluminum silicate and silica have a dielectric constant of 5 or less.

In a particular implementation, the ceramic-core comprises, by weight, more than five percent (5%) of each of the following: magnesium aluminum silicate; magnesium silicate; and magnesium aluminate. In a more particular implementation, the ceramic-core comprises, by weight, more than fifteen percent (15%) magnesium aluminum silicate, more than five percent (5%) magnesium aluminate, and more than ten percent (10%) magnesium silicate, wherein the ceramic-core has a dielectric constant of 6 or less. In these and other implementations, the ceramic-core can optionally comprise other constituents, for example fillers or additives.

In an alternative implementation, the ceramic-core comprises, by weight, each of the following: between 41-54% silicon dioxide; between 27-38% aluminum oxide; between 10-17% magnesium oxide, wherein the ceramic-core has a dielectric constant of 5 or less. Other components of this alternative composition can comprise as much as 12% tin oxide, as much as 7% titanium oxide, and as much as 2% lanthanum oxide, among other additives. These or other additives to the ceramic-core composition can slightly increase the dielectric constant, possibly greater than 5.

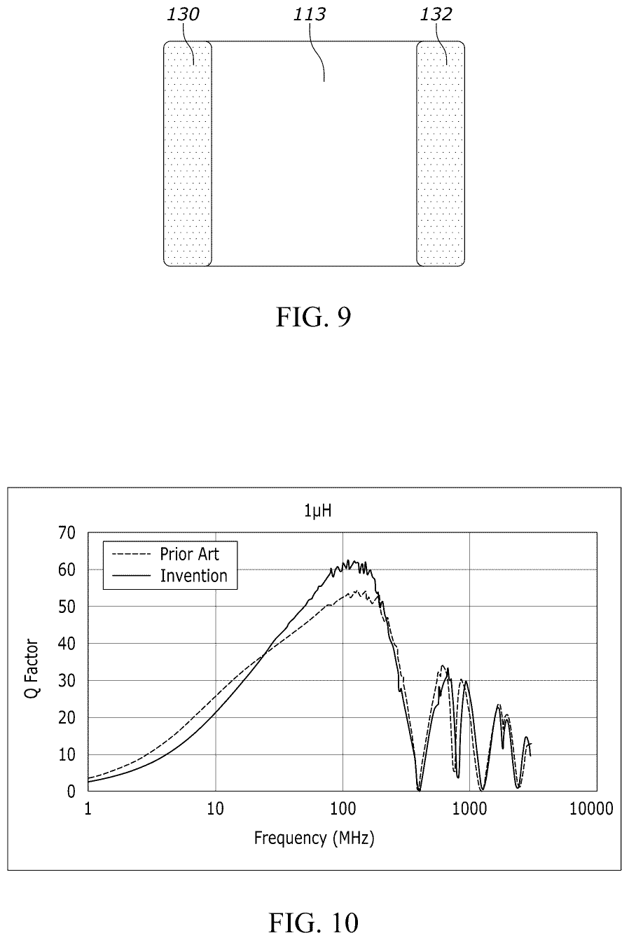

The conductive coil comprises end portions electrically connected to corresponding electrical terminals integrated with the ceramic-core. The terminals can be configured as metallized or other conductive pads located on corresponding standoffs or on other portions of the ceramic-core, depending on how the component will be electrically integrated with (e.g., mounted on) the host device. In FIGS. 8-9, first and second terminals 130 and 132 are formed on end surfaces (shown in FIGS. 5 and 7) of first and second standoffs. FIGS. 2-4 illustrate different views of the electrical terminals 130 and 132. Each electrical terminal can optionally wrap around and cover a side wall portion of the corresponding standoff to increase the contact area between the terminals and the ceramic-core, as shown in FIGS. 2-3 and FIGS. 8-9. In FIGS. 8-9, the terminals 130 and 132 on the end surfaces of the standoffs constitute mounting surfaces. Thus configured, the ceramic-core inductor component can be electrically and mechanically integrated with a host device (e.g., a PCB) by reflow or wave soldering or some other electrical and mechanical integration operation.

In other implementations, the electrical terminals can be located on a surface of the ceramic-core other than the mounting surface. Thus configured, the mounting surface of the ceramic-core inductor component can be mechanically fastened to the host device (e.g., by a bonding material) and the electrical terminals located on different portions of the ceramic-core can be electrically integrated with the host device by a wire bond, solder, or some other conductor-connecting means.

In one implementation, the electrical terminals comprise a conductive base-layer plated with one or more conductive outer layers. The base-layer can comprise silver or some other high conductivity metal or alloy. In one implementation, the base-layer comprises a silver (Ag) frit deposited onto select portions of the ceramic-core (e.g., the standoff mounting surfaces). Other conductors can be used alternatively. The base-layer can be applied to the ceramic-core in a dipping or other known or future operation.

An outermost conductive layer can be formed directly on the base-layer or on an intermediate conductive layer. The outermost conductive layer composition can be selected to improve solderability (e.g., improved wetting) and antioxidation, among other properties of the termination. In one implementation, the outermost conductive layer is tin (Sn) or a tin-based alloy (e.g., SnPb). Other conductors can be used alternatively. The conductive outermost layer can be applied to the base-layer or to the intermediate layer in an electroplating operation among other known or future processes.

In some implementations, an intermediate conductive layer is located between the base-layer and the outermost conductive layer to protect the base-layer. For example, the intermediate layer can have a higher melting temperature than the base-layer. In one implementation, the intermediate layer comprises copper (Cu). Alternatively, the intermediate layer can be nickel (Ni) or some other conductor or alloy. The conductive intermediate layer can be applied to the base-layer in an electroplating operation among other known or future processes.

In other implementations, the electrical terminals comprise a silver-platinum-palladium (AgPtPd) alloy deposited onto select portions of the ceramic-core. Other platinum group metals or alloys can be used alternatively. Representative low melting point solders developed for surface-mount ceramic component terminations comprising such alloys include solder type Sn62, among others. The electrical terminals can be applied to the ceramic-core in a dipping or other known or future operation.

The conductive coil can comprise a solid or hollow-core wire. In one implementation, the conductive coil is formed from a solid copper wire, among other good conductors. In another implementation, the conductive coil comprises a non-copper (e.g., aluminum) inner-core plated with copper or silver. The wire can optionally comprise a non-conductive outer sheath, like enamel, for electrical insulation. The wire can be wound about the ceramic-core in a coil winding operation after terminal formation. End portions of the conductive coil can be electrically connected to corresponding terminals by a spot or other welding operation, soldering, wire bonding or some other electrical integration operation. In some implementations, the end portions of the conductive coil are flattened prior to electrical integration. In FIG. 4, each end portion 121 and 123 of the conductive coil 120 is electrically integrated with corresponding terminals 130 and 132 located on the end surface of the corresponding standoff.

The ceramic-core inductor components described herein can be configured for surface mounting or other integration with the host device. In FIG. 2, the first and second standoffs are located to orient an axis of the conductive coil parallel to the mounting surface 102 of the host when the ceramic-core inductor component 100 is mounted on the mounting surface. The first and second standoffs 124 and 126 are sized to space the conductive coil apart from the mounting surface when the ceramic-core inductor component is mounted on the mounting surface.

In some implementations, the ceramic-core inductor component comprises a non-conductive handle to accommodate automated pick and place assembly and other component handling operations. The non-conductive handle covers at least a portion of the inductor component. In FIGS. 2-4, the ceramic-core inductor components 100 comprise a non-conductive handle 136 located on a portion of the ceramic-core opposite the standoffs. In other implementations, the non-conductive handle covers all portions of the inductor component except for the electrical terminals. The non-conductive handle can comprise an epoxy, plastic, resin, or other non-conductive material. The non-conductive handle can be applied by a dipping, spraying or other application operation after assembly of the coil about the ceramic-core.

Representative dimensions for the ceramic-core inductor components described herein are depicted in Table I below. The “Size” refers to the length and width dimensions of the mounting surface area of the component. The sizes disclosed below are typical of surface-mount components and are not intended to limit the scope of the disclosure. In other implementations, the ceramic-core inductors described herein can be larger or smaller than the sizes depicted below, depending on electrical and performance requirements and integration constraints for the intended use case.

TABLE I

| Size | Size | Length | Width | Height | Min | | Max | |
|---|---|---|---|---|---|---|---|---|
| Metric | Imperial | (mm) | (mm) | (mm) | Inductance | | Inductance | |
| 1005 | 0402 | 1.00 | 0.50 | 0.60 | 0.8 | nH | 1000 | nH |
| 1608 | 0603 | 1.60 | 0.80 | 0.80 | 1 | nH | 3 | μH |
| 2012 | 0805 | 2.00 | 1.25 | 1.40 | 1.8 | nH | 10 | μH |
| 2520 | 1008 | 2.50 | 2.02 | 1.80 | 3 | nH | 10 | μH |
| 3225 | 1210 | 3.06 | 2.40 | 1.90 | 3 | nH | 10 | μH |

The inductance of the ceramic-core inductor component is a function of the geometry of the coil (e.g., number of coil-turns, length, and cross-sectional area of the coil) as well as the magnetic permeability of the ceramic-core and neighboring materials. Thus, the range of inductance values for the ceramic-core inductor components described herein are generally constrained by the size of the component and the nature of the ceramic-core and surrounding materials. Typical minimum inductor values for the representative ceramic-core inductor component sizes in Table I range between 0.8 nH and 3 pH. However, the inductance can be larger or smaller, depending on electrical and performance requirements and integration constraints for the intended use case.

Table II below shows measured characteristics of a prior art 1 μH ceramic-core inductor and a 1 μH ceramic-core inductor having a dielectric constant of 5 or less according to the present invention. Both inductors have an inductance of 1 μH with a tolerance of 10% or less. The inductor according to the present invention has higher minimum and maximum Q factors, and a higher SRF than the prior art inductor. The Size represents the length and width dimensions (i.e., 2.5 mm by 2.0 mm) of the components.

TABLE II

| | | Inductance | | | |
|---|---|---|---|---|---|
| | | (nH) @ | Q min @ | | SRF |
| 1 μH | Size | 25 MHz | 50 MHz | Max Q | (MHz) |
| Prior art | 2520 | 935 | 46 | 55 @ 122 MHz | 395 |
| Invention | 2520 | 988 | 50 | 62 @ 110 MHz | 405 |

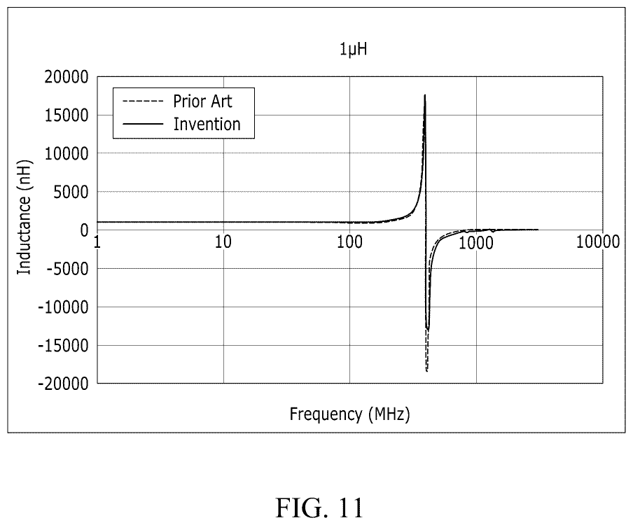

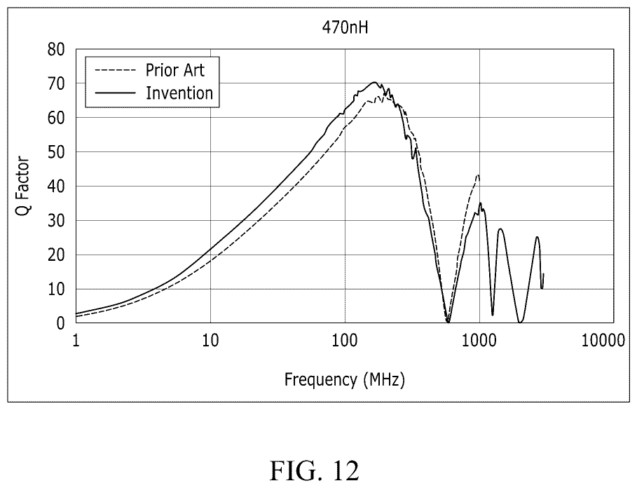

FIG. 11 illustrates plots of measured Q factor versus frequency for the 1 μH ceramic-core inductors depicted in Table II. The higher Q factor of the ceramic-core inductor of the present invention is indicative of higher efficiency (i.e., reduced parasitic loss) than the prior art inductor and thus improved performance. FIG. 12 illustrates plots of measured inductance versus frequency for the 1 pH ceramic-core inductors depicted in Table II.

Table III below shows measured characteristics of a prior art 470 nH ceramic-core inductor and a 470 nH ceramic-core inductor having a dielectric constant of 5 or less according to the present invention. Both inductors have an inductance of 470 nH with a tolerance of 5% or less. The inductor according to the present invention has higher minimum and maximum Q factors, and a higher SRF than the prior art inductor. The Size represents the length and width dimensions (i.e., 2.5 mm by 2.0 mm) of the components.

TABLE III

| | | Inductance | | | |
|---|---|---|---|---|---|
| | | (nH) @ | Q min @ | | SRF |
| 470 nH | Size | 25 MHz | 100 MHz | Max Q | (MHz) |
| Prior art | 2520 | 452 | 57 | 66 @ 182 MHz | 575 |
| Invention | 2520 | 464 | 63 | 70 @ 159 MHz | 589 |

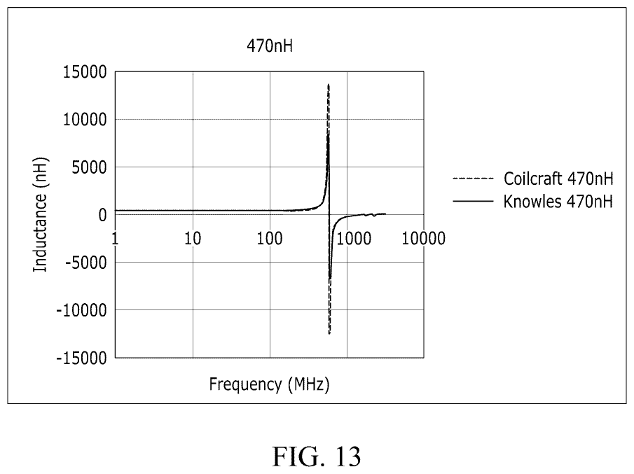

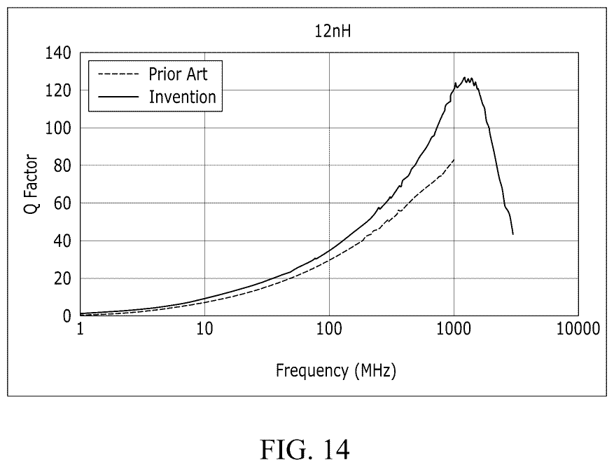

FIG. 13 illustrates plots of measured Q factor versus frequency for the 470 nH ceramic-core inductors depicted in Table III. The higher Q factor of the ceramic-core inductor of the present invention is indicative of higher efficiency (e.g., reduced parasitic loss) than the prior art inductor and thus improved performance. FIG. 14 illustrates plots of measured inductance versus frequency for the 470 nH ceramic-core inductors depicted in Table III.

Table IV below shows measured characteristics of a prior art 12 nH ceramic-core inductor and a 12 nH ceramic-core inductor having a dielectric constant of 5 or less according to the present invention. Both inductors have an inductance of 470 nH with a tolerance of 5% or less. The inductor according to the present invention has higher minimum and maximum Q factors, and a higher SRF than the prior art inductor. The Size represents the length and width dimensions (i.e., 2.5 mm by 2.0 mm) of the components.

TABLE IV

| | | Inductance | | | |
|---|---|---|---|---|---|
| | | (nH) @ | Q min @ | | SRF |
| 12 nH | Size | 25 MHz | 500 MHz | Max Q | (MHz) |
| Prior art | 2520 | 12 | 67 | 89 @ 1000 MHz | >1000 |
| Invention | 2520 | 11.6 | 82 | 120 @ 1000 MHz | >3000 |

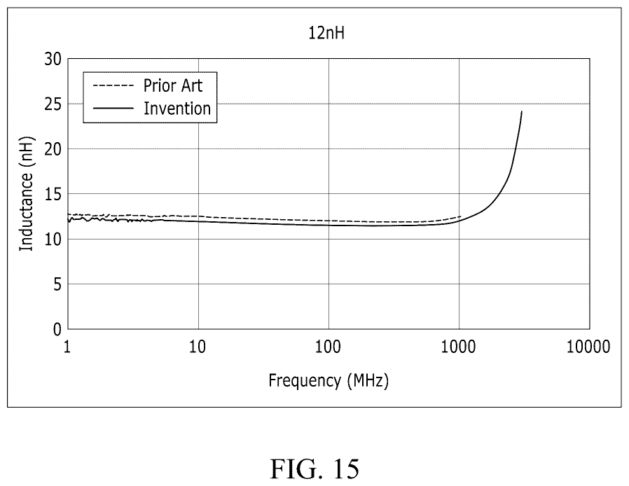

FIG. 15 illustrates plots of measured Q factor versus frequency for the 12 nH ceramic-core inductors depicted in Table IV. The higher Q factor of the ceramic-core inductor of the present invention is indicative of higher efficiency (e.g., reduced parasitic loss) than the prior art inductor and thus improved performance. FIG. 16 illustrates plots of measured inductance versus frequency for the 12 nH ceramic-core inductors depicted in Table IV.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is claimed is:

1. A ceramic-core inductor component comprising:
a ceramic-core comprising a ceramic body portion located between first and second ceramic standoffs,
the ceramic-core comprising a dielectric constant less than 8;
a conductive coil disposed about the ceramic body portion; and
a first terminal disposed on a first surface of the first ceramic standoff and a second terminal disposed on a second surface of the second ceramic standoff,
a first end-portion of the conductive coil electrically connected to the first terminal and a second end-portion of the conductive coil electrically connected to the second terminal.

2. The ceramic-core inductor component of claim 1 is a surface-mountable device, wherein the first and second terminals each comprises a conductive pad and each of the first and second ceramic standoffs is located to orient an axis of the conductive coil parallel to a mounting surface when the ceramic-core inductor component is mounted on the mounting surface.

3. The ceramic-core inductor component of claim 2 further comprising a non-conductive handle fastened to the ceramic-core and at least partially covering the conductive coil.

4. The ceramic-core inductor component of claim 2, wherein the ceramic-core comprises a dielectric constant of 6 or less.

5. The ceramic-core inductor component of claim 4 is a 1 μH inductor with a tolerance of 10% or less comprising a Q factor greater than 50 and a self-resonant frequency greater than 400 MHz.

6. The ceramic-core inductor component of claim 4 is a 470 nH inductor with a tolerance of 5% or less comprising a Q factor greater than 60 and a self-resonant frequency greater than 550 MHz.

7. The ceramic-core inductor component of claim 4 is a 12 nH inductor with a tolerance of 5% or less comprising a Q factor greater than 80 and a self-resonant frequency greater than 3000 MHz.

8. The ceramic-core inductor component of claim 4, wherein the ceramic-core comprises, by weight, more than five percent (5%) of each of magnesium aluminum silicate, magnesium silicate and magnesium aluminate.

9. The ceramic-core inductor component of claim 4, wherein the ceramic-core comprises, by weight, more than fifteen percent (15%) magnesium aluminum silicate, more than five percent (5%) magnesium aluminate, and more than ten percent (10%) magnesium silicate.

10. The ceramic-core inductor component of claim 4, wherein the ceramic-core comprises, by weight, between 41%-54% silicon dioxide, between 27%-38% aluminum oxide, and between 10%-17% magnesium oxide.

11. The ceramic-core inductor component of claim 10, wherein the ceramic-core further comprises, by weight, as much as 12% tin oxide; as much as 7% titanium oxide; and as much as 2% lanthanum oxide.

12. The ceramic-core inductor component of claim 2, wherein the ceramic-core comprises one or more of calcium-strontium tungstate, magnesium silicate, magnesium aluminate, magnesium aluminum silicate, calcium silicate, zinc silicate, aluminum silicate or silica.

13. A ceramic-core inductor component comprising:
a pressed ceramic-core comprising a dielectric constant 5 or less,
a wire coil disposed about the ceramic-core; and
a first end-portion of the wire coil electrically connected to a first terminal of the ceramic-core and a second end-portion of the wire coil electrically connected to a second terminal of the ceramic-core.

14. The ceramic-core inductor component of claim 13, wherein the ceramic-core comprises, by weight, between 41%-54% silicon dioxide, between 27%-38% aluminum oxide, and between 10%-17% magnesium oxide.

15. The ceramic-core inductor component of claim 14, wherein the ceramic-core further comprises, by weight, as much as 12% tin oxide; as much as 7% titanium oxide; and as much as 2% lanthanum oxide.

16. The ceramic-core inductor component of claim 13, wherein the ceramic-core comprises, by weight, more than fifteen percent (15%) magnesium aluminum silicate, more than five percent (5%) magnesium aluminate, and more than ten percent (10%) magnesium silicate.

17. The ceramic-core inductor component of claim 16 is a 1 μH inductor with a tolerance of 10% or less comprising a Q factor greater than 50 and a self-resonant frequency greater than 400 MHz.

18. The ceramic-core inductor component of claim 16 is a 470 nH inductor with a tolerance of 5% or less comprising a Q factor greater than 60 and a self-resonant frequency greater than 550 MHz.

19. The ceramic-core inductor component of claim 16 is a 12 nH inductor with a tolerance of 5% or less comprising a Q factor greater than 80 and a self-resonant frequency greater than 3000 MHz.

20. The ceramic-core inductor component of claim 16, wherein the first terminal is a first metallized pad integrated with a first portion of the pressed ceramic-core, and the second terminal is a second metallized pad integrated with a second portion of the ceramic-core.

21. The ceramic-core inductor component of claim 20 further comprising a non-conductive handle fastened to the pressed ceramic-core and at least partially covering the wire coil.

22. The ceramic-core inductor component of claim 21 is a size 2520 surface-mount component.
